(19) United States
(12) Patent Application Publication
(10) Pub. No.: US 2025/0107541 A1
(43) Pub. Date: Apr. 3, 2025

(54) IMPROVED BIOLOGICALLY DERIVED FOOD PRESERVATIVE

(71) Applicant: IMPACT BIOLIFE SCIENCE, INC., Houston, TX (US)

(72) Inventor: Daryl L. Thompson, Winter Haven, FL (US)

(21) Appl. No.: 18/728,279

(22) PCT Filed: Jan. 11, 2022
(86) PCT No.: PCT/US2022/011984

§ 371 Date: Jul. 11, 2024

(51) Int. Cl. A23B 2/771; A23B 2/733; A23B 2/75; A23B 45/00

(52) U.S. Cl. CPC A23B 2/771; A23B 2/733; A23B 2/75; A23B 45/00

(57) ABSTRACT

A food preservative includes a synergistic combination of a polyphenolic compound and a phenolic aldehyde. In one advantageous form, the polyphenolic compound is selected from the group consisting of hesperidin, ellagic acid, catechin, epigallocatechin, crude extract of citrus, pomegranate, and a crude extract of green tea and the phenolic aldehyde is vanillin. Advantageously, the composition has synergistic effects to limit microbial growth, acting as an antimicrobial agent and/or an antioxidant.

### FIELD OF THE INVENTION

The present invention relates to a food preservative and method for preserving food and in particular a food preservative and method which combines a polyphenolic compound and a phenolic aldehyde.

### BACKGROUND OF THE INVENTION

Food preservatives provide enhanced food shelf life and help eliminate food waste. Typically, food preservatives act to limit microbial growth thereby preventing their growth. Prior food preservatives include agents which reduce the growth or kill microbes. These include use of compounds or chemicals as well as atmospheric or environmental conditions and also include use of electromagnetic treatments such as UV and IR and also include application of heat and/or pressure.

U.S. Patent Application Publication No. 2005/0196492 describes the use of vanillin and isothiocyanate compounds as a food preservative agent. In particular this publication discloses the use of this formula as a antimicrobial additive for food packaging.

Traditionally food additives are antimicrobial by nature especially as antibacterial, antifungal, and anti-mold. The most common food preservatives in use are calcium propionate, sodium nitrate, sodium nitrite, sulfites, and EDTA.

Another aspect of food preservation is the use of oxygen scavengers or antioxidants which inhibit the oxidation of food components. These include butylated hydroxyanisole (BHA), butylated hydroxytoluene (BHT), sulfur dioxide, ascorbic acid, and tocopherol.

Although effective, these food additives can cause adverse health effects. For instance, sodium nitrate can react with protein sunder high heat to form carcinogenic nitrosamines. Sodium benzoate, a common food preservative can form carcinogenic benzene when combined with ascorbic acid. It has also been conclusively proven that food preservatives and food commercial grade food coloring has been responsible for a significant rise in hyperactivity in children and adults.

Food companies globally are searching for new formulations with a higher degree of effectiveness while utilizing more natural based solutions in an effort to decrease reliance on synthetic preservatives.

### SUMMARY OF THE INVENTION

The present invention is directed to improving the shelf life of food or preserving food by reducing or eliminating growth of microbes which include bacteria and mold using a synergistic combination of a polyphenolic compound and a phenolic aldehyde. The polyphenol includes but is not limited to hesperidin, ellagic acid, catechin, epigallocatechin, crude extract of citrus, pomegranate, and a crude extract of green tea.

The phenolic aldehyde includes but is not limited to vanillin. In one specific advantageous form, the composition comprises hesperidin and vanillin. Beneficially, the combination of a polyphenolic compound (e.g. hesperitin) and a phenolic aldehyde (e.g. vanillin) has a synergistic effect in food preservation by affecting bacterial and/or mold metabolism. In various forms, the present composition when presented to bacteria and/or mold may act as both an antimicrobial and/or an antioxidant.

Antimicrobial activity of the present composition is observed in various bacteria or fungi which include but are not limited to Aspergillus spp, Penicillium spp, Rhizopus spp, Bacillus spp, Eurotium spp. and Candida spp.

In one further advantageous form, the present composition inhibits mold growth by inhibiting a biofilm formation by mold via two distinct inhibitory pathways initiated by the polyphenol compound and the phenolic aldehyde acting synergistically with each other.

In still yet another form, the present composition acts synergistically when administered to a microbe by inhibiting exozymes such as β-lactamase.

In yet another advantageous form, the present composition reduces mold growth by inhibiting or disrupting iron and folate dependent metabolic mechanisms.

In still yet another form, the present composition inhibits mold cellular integrity by downregulation of ergosterol function by differential and independent mechanisms attributed to the polyphenolic composition and the phenolic aldehyde.

The present invention, in one form thereof, is directed to a food preservative which comprises a polyphenolic compound and a phenolic aldehyde. The polyphenolic compound comprises one or more compounds selected from the group consisting of hesperidin, ellagic acid, catechin, epigallocatechin, crude extract of citrus, pomegranate, and a crude extract of green tea. In one specific further form, the phenolic aldehyde is vanillin.

The ratio of polyphenolic compound to phenolic aldehyde can be 1:1. Alternatively, the amount can be 1% polyphenolic compound and 99% phenolic aldehyde.

In yet another form, the polyphenolic compound is present in 99% and the phenolic aldehyde is present in 1%.

In still yet another form, the polyphenolic compound is present in 25% and the phenolic aldehyde is present in 75%.

In still yet another form, the polyphenolic compound is present in 75% and the phenolic aldehyde is present in 25% in the food preservation composition.

The present invention, in another form thereof, is directed to a method for preserving food by combining a polyphenolic compound selected from the group consisting of hesperidin, ellagic acid, catechin, epigallocatechin, crude extract of citrus, pomegranate, and a crude extract of green tea, with a phenolic aldehyde, and applying the combination with a food product, to thereby limit the growth of microorganisms selected from the group consisting of bacteria and mold.

### BRIEF DESCRIPTION OF THE FIGURES

FIG. 1 comprises a series of photographs demonstrating antimicrobial effects of the present composition in accordance with the present invention.

FIG. 2 comprises tables summarizing antimicrobial effects in accordance with the present invention.

FIG. 3 comprises tables summarizing antimicrobial effects in accordance with the present invention.

FIG. 4 are tables showing antimicrobial effects of green tea polyphenol and vanillin in accordance with the present invention.

### DETAILED DESCRIPTION

The present invention will now be described with regard to exemplary embodiments or form of a food preservative and experiments conducted which demonstrate efficacy and in particular synergistic effects from combining a polyphenolic compound and a phenolic aldehyde.

### Effective Amount:

The preferred dose or amount of the food preservative (polyphenolic compound and phenolic aldehyde), in accordance with the present invention is that amount which will be effective in limiting the growth of microbes including but not limited to Aspergillus spp, Penicillium spp, Rhizopus spp, Bacillus spp, Eurotium spp. and Candida spp. An “effective amount” of the composition to be used in accordance with the invention is intended to mean a sufficient amount of the food preservative, such that the desired antimicrobial effect is achieved and/or food preservation is achieved. Thus, the exact amount of the food preservative required will vary depending of the food and/or microbe(s) to control and will vary depending on the species, environmental conditions of temperature, light, humidity, etc. mode of application or use and the like.

Accordingly, the “effective amount” of any particular food preservative will vary based on the particular circumstances, and an appropriate effective amount may be determined in each case of application by one of ordinary skill in the art using only routine experimentation.

The present food preservative is directed to a global need to increase effectiveness of food preservation especially in baked goods. The present composition has synergistic effects from the combination of polyphenols with phenolic aldehyde. Further, the synergistic effects are achieved through various specific ratios of polyphenolic compounds with phenolic aldehyde.

Advantageously, the synergistic effects from combining specific polyphenolic compounds in respective ratios with phenolic aldehyde has both antimicrobial effects and antioxidant effects on microbes.

### Discussion of Experimental Result

Testing was undertaken to determine the effects of different modalities of the formula as applied to mold inhibition within baked goods. Calpro (calcium propanoate), a typically mold inhibitor in baked goods was used as the control. Citrus polyphenol (CPP) or hesperidin), pomegranate polyphenol (ellagic acid, epigallocatechin) and green tea polyphenol (catechin) as was vanillin (aldehyde) were tested alone. Further formulations of (hesperidin+vanillin), (ellagic acid, epigallocatechin)+vanillin, and (catechin+vanillin) were tested as well.

The results showed limited activity with the single modalities of hesperidin, ellagic acid, epigallocatechin, catechin and vanillin. The Calpro (calcium propanoate) performed as expected. However the combined formulas (hesperidin+vanillin), (ellagic acid, epigallocatechin+vanillin) and (catechin+vanillin) outperformed all other testing vehicles in regards to mold inhibition.

These effects cannot be contributed to an “additive” effect but are synergistic due to the significant increase in antimicrobial activity as well as increased efficacy without the requirement of increased dosage. In fact the data reflect that increased dosage did not contribute to increased efficacy which negates an argument of additive effects.

### Experimental Results

The below experimental results further explain and clarify the nature of the synergistic effects of combined polyphenols with aldehydes.

Vanillin alone sometimes had significant inhibitory effects, but not in all tests and not always the same effects.

Polyphenols alone have significant effects, but not in all tests and not against molds and not always in increasing doses.

There are differences in polyphenol effects, pomegranate polyphenols (ellagic acid, epigallocatechin) is much less active than citrus (hesperidin) or green tea polyphenols (catechin).

Testing research and data demonstrated that the combination of polyphenols and aldehyde created results that revealed effects that are synergistic in nature.

The combined formulas of polyphenols and aldehydes demonstrated superior antimicrobial affects as well as enhanced food preservation capabilities.

The following are shown below: University in vitro test, in-house test bakery results, Research Institute in vitro test, and University micro-bread challenge test.

TABLE 1
University in vitro test results (96 well microtiter plates)

| | Days to visually see mold growth | | |
|---|---|---|---|
| | A. niger | P. paneum | P. roqueforti |
| Control | 3 | 6 | 4 |
| CalPro 0.3% (pH 5.5) | 4 | 6 | 6 |
| CalPro 0.3% (pH 5.0) | 5 | 6 | 7 |
| Citrus Polyphenol (CPP, hesperitin | 3 | 6 | 4 |
| component) 0.1% | | | |
| Vanillin 0.1% | >7 | >7 | >7 |
| CPP 0.05% + Vanillin 0.05% | >7 | >7 | >7 |
| Pomegranate Polyphenol (PGPP) | 3 | 6 | 5 |
| 0.1% | | | |
| PGPP 0.05% + Vanillin 0.05% | >7 | >7 | >7 |
| Green tea Polyphenol (GTPP) 0.1% | 3 | 6 | 6 |
| GTPP 0.05% + Vanillin 0.05% | >7 | >7 | >7 |

Equal or longer than Calpro
Shorter than Calpro

In-house bakery in vivo test results

(Standard 400-gram loaves, EU tin bread and US tin bread)
Bake tests with different bread systems (EU and US).
Additions: Vanillin, CPP, CPP+vanillin, GTPP+vanillin, PPP, PPP+vanillin (all in 3 different dose rates).
Reference was calcium propionate (0.3%).
These tests were ‘obscured’ because the new bakery which was not yet as ‘spoiled’ as a regular (industrial) bakery. This resulted in mold-free shelf lives (MFSL), of control bread of 18-20 days. Normal is 5-7 days.
All breads with calcium propionate had shelf lives of >45 days (normal is 15-18 days).
Most breads with polyphenol and polyphenol/phenol blends had similar >45 days.
NB. These effects were not always seen at highest dosages.
Vanillin alone in some cases had >45 days and in other cases ‘only’ 22-23 days.

TABLE 2

| | MFSL (visual only) |
|---|---|
| Control | 18 |
| CalPro 0.3% (pH 5.5) | 45 |
| CalPro 0.3% (pH 5.0) | nd |
| Citrus polyphenol (CPP, hesperitin | 25 |
| component) 0.1% | |
| Vanillin 0.1% | 21-45 |
| CPP (hesperitin component) | 45 |
| 0.05% + Vanillin 0.05% | |
| Pomegranate polyphenol (PGPP) 0.1% | 21 |
| PGPP 0.05% + vanillin 0.05% | 25 |
| Green tea polyphenol (GTPP) 0.1% | 45 |
| GTPP 0.05% + vanillin 0.05% | 45 |
| | Equal or longer than Calpro |
| | Shorter than Calpro |

Research Institute in vitro test results
Solutions of the various antimicrobials were inoculated with 3 different molds and with other fungi.
Fungicidal and fungistatic activity was measured.
Molds investigated: Penicillium roqueforti, Aspergillus brasiliensi, Penicillium aurantiogriseum.
Effect on Saccharomyces cerevisiae was measured.

TABLE 3

| Product | Fungicidal activity | Fungistatic activity |
|---|---|---|
| Citrus polyphenol (CPP) | no activity | No fungistatic activity |
| Vanillin | >1 log reduction | Fungistatic against all |
| | S. cerevisiae | mold, but also against |
| | | [also S. cerevisiae], |
| | | greater than 10% CalPro |
| CPP + vanillin | >1 log reduction | Equal/greater than 10% |
| | S. cerevisiae | CalPro against 3 molds, |
| | | no activity against |
| | | S. cerevisiae |
| Green Tea polyphenol | >4 log reduction | Fungistatic activity |
| (GTPP) | S. cerevisiae | against 2 of the 3 molds |
| GTPP + vanillin | >1 log reduction | Equal/greater than 10% |
| | A. brasiliensi | CalPro against 3 molds, |
| | >1 log reduction | no activity against |
| | S. cerevisiae | S. cerevisiae |
| Pomegranate polyphenol | >1 log reduction | No fungistatic activity |
| (PPP) | S. cerevisiae | |
| PPP + vanillin | >1 log reduction | ? |
| | A. brasiliensi | |
| | >4 log reduction | |
| | S. cerevisiae | |

University micro-bread (in vivo) challenge test
10 gram loaves.
All antimicrobial compounds in 3 dose rates.
Challenge with 50 spores A. niger or 30 spores P. roqueforti.
Spores on crust and on crumb.
Evaluated visually only: No growth, start growth, growth.

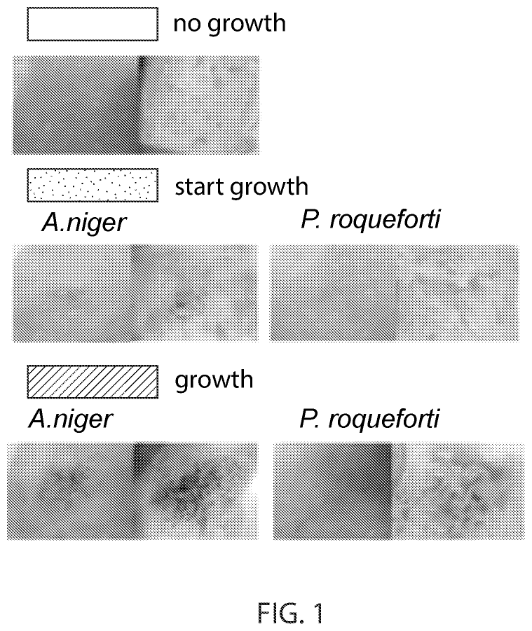

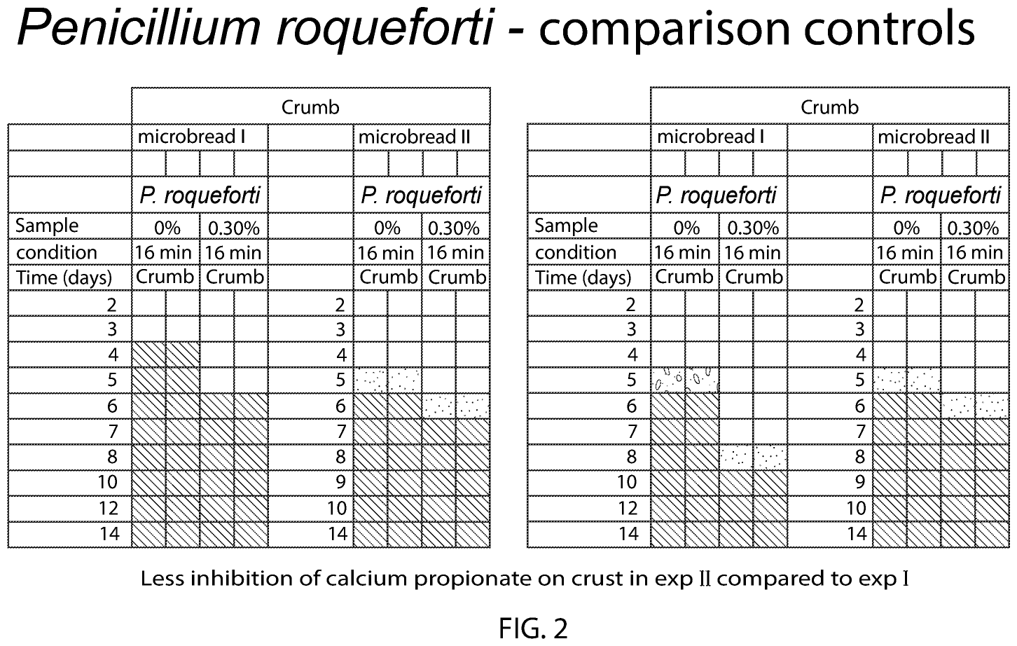

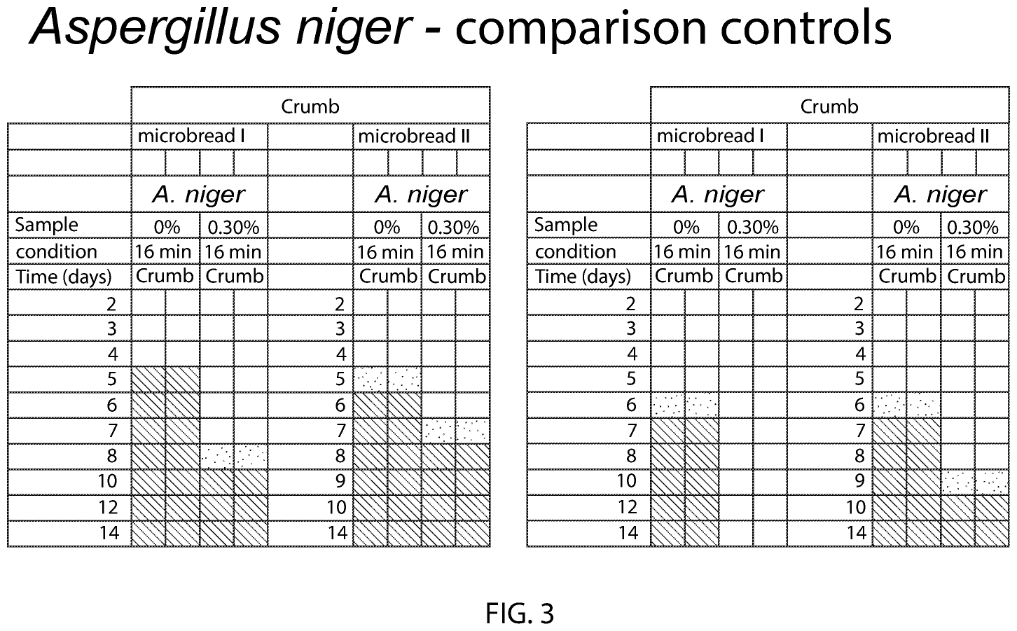

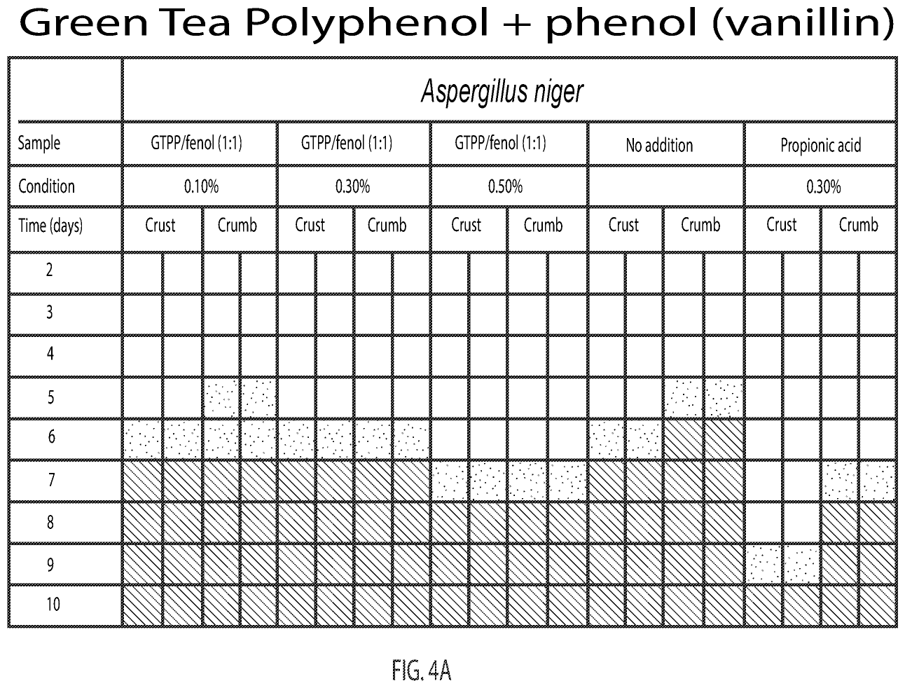

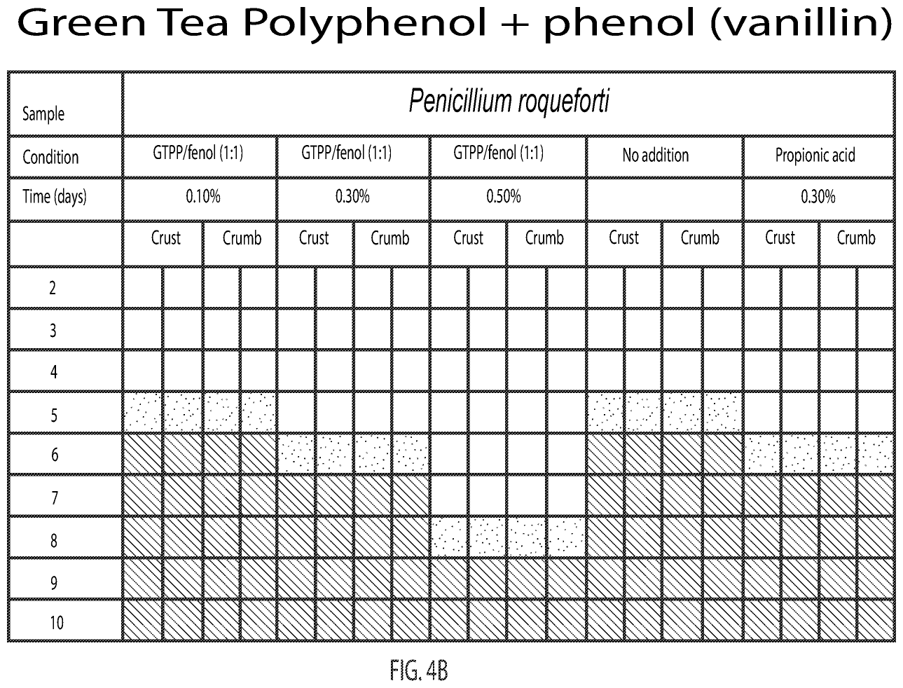

Data for these experiments are presented in FIGS. 1-4.

With reference to FIGS. 1-4:

On A. nigers:

0.5% compared to control:
1 day delay crust
2 days delay crumb

0.5% for crumb comparable to propionic acid.

On P. roqueforti:

0.5% compared to control:
3 days delay crust
3 days delay crumb

0.5% shows more inhibition than propionic acid for crust and crumb

GTPP alone (results not shown)
No inhibition of A. niger (crust and crumb).
Significant inhibition of P. roqueforti (two (2) days longer than CalPro), but only at lowest does rate

### CONCLUSIONS

The combination of polyphenol+phenol (vanillin) has significant anti-mold activity.

Although the invention has been described above in relation to preferred embodiments thereof, it will be understood by those skilled in the art that variations and modifications can be accomplished in these preferred embodiments without departing from the scope and spirit of the invention.

1. A food preservative composition comprising:
a polyphenolic compound selected from the consisting of hesperidin, ellagic acid, catechin, epigallocatechin, crude extract of citrus, pomegranate, and a crude extract of green tea; and
a phenolic aldehyde.

2. The food preservative of claim 1, wherein the phenolic aldehyde comprises vanillin.

3. The food preservative of claim 2, wherein the polyphenolic compound comprises hesperidin.

4. The food preservative of claim 1, wherein the composition limits growth or prevents growth of microorganisms when exposed to the composition.

5. The food preservative of claim 4, wherein said microorganisms are mold.

6. The food preservative of claim 4, wherein said organisms are bacteria.

7. The food preservative of claim 4, wherein the microorganisms are selected from the group consisting of Aspergillus spp, Penicillium spp, Rhizopus spp, Bacillus spp, Eurotium spp. and Candida spp.

8. The food preservative of claim 1, wherein the composition reduces mold growth when exposed thereto.

9. The food preservative of claim 8, wherein mold growth is reduced by the composition by reducing or inhibiting a biofilm formation by mold, via the composition affecting two distinct inhibitory pathways of the mold.

10. The food preservative of claim 8, wherein the composition disruptions iron and folate dependent metabolic mechanisms of mold generation, when the mold is exposed to the composition.

11. The food preservative of claim 8, wherein the composition disrupts mold cellular integrity when exposed to the composition by down regulation of ergosterol function of the mold.

12. The food preservative of claim 1, wherein the composition inhibits or reduces the reproduction of one or more exozymes by microorganisms exposed to the composition.

13. The food preservative of claim 12, wherein the one or more one or more exozymes comprises β-lactamase.

14. The food preservative of claim 1, wherein a ratio of the polyphenolic compound to the phenolic aldehyde is 1:1.

15. The food preservation of claim 1, wherein the polyphenol compound is present in the composition in 50%; and the phenolic aldehyde is vanillin present in 50% of the composition.

16. The food preservative of claim 1, wherein the polyphenol compound is present in the composition in 1%; and the phenolic aldehyde is vanillin present in 99% of the composition.

17. The food preservative of claim 1, wherein the polyphenol compound is present in the composition in 99%; and the phenolic aldehyde is vanillin present in 1% of the composition.

18. The food preservative of claim 1, wherein the polyphenol compound is present in the composition in 25%; and the phenolic aldehyde is vanillin present in 75% of the composition.

19. The food preservative of claim 1, wherein the polyphenol compound is present in the composition in 75%; and the phenolic aldehyde is vanillin present in 25% of the composition.

20. A method for preserving food, comprising combining a polyphenolic compound selected from the group consisting of hesperidin, ellagic acid, catechin, epigallocatechin, crude extract of citrus, pomegranate, and a crude extract of green tea and a phenolic aldehyde, with a food product, to thereby limit the growth of microorganisms selected from the group consisting of bacteria and mold.

21. The method of claim 20, wherein the polyphenol compound is present in the composition in 50%; and the phenolic aldehyde is vanillin present in 50% of the composition.

22. The method of claim 21, wherein the polyphenol compound is present in the composition in 1%; and the phenolic aldehyde is vanillin present in 99% of the composition.

23. The method of claim 21, wherein the polyphenol compound is present in the composition in 99%; and the phenolic aldehyde is vanillin present in 1% of the composition.

24. The method of claim 21, wherein the polyphenol compound is present in the composition in 25%; and the phenolic aldehyde is vanillin present in 75% of the composition.

25. The method of claim 23, wherein the polyphenol compound is present in the composition in 75%; and the phenolic aldehyde is vanillin present in 25% of the composition.
